(19) United States
(12) Patent Application Publication
(10) Pub. No.: US 2025/0135661 A1
(43) Pub. Date: May 1, 2025

(54) ROBOT HAND

(71) Applicant: FANUC CORPORATION, Yamanashi (JP)

(72) Inventor: Yoshinori OCHIISHI, Yamanashi (JP)

(21) Appl. No.: 18/682,459

(22) PCT Filed: Sep. 16, 2021
(86) PCT No.: PCT/JP2021/034107

§ 371 Date: Feb. 9, 2024

(51) Int. Cl. B25J 15/08

(52) U.S. Cl. CPC B25J 15/08

(57) ABSTRACT

A robot hand is provided with a pair of fingers provided so as to freely approach and separate from each other in order to hold a workpiece therebetween, and a pair of jaw members provided on the pair of fingers, respectively, in order to hook another workpiece. The jaw members are provided so as to be changeable between a state of protruding from the contact surfaces of the fingers with the workpiece and a state of being pushed into the fingers.

### TECHNICAL FIELD

This disclosure relates generally to a robot hand.

### BACKGROUND ART

With the spread of robots, various hands have been proposed depending on the workpiece to be handled. For example, when a workpiece such as a can or a PET bottle is conveyed by a hand, a method of gripping the workpiece is generally used. In order to grip the workpiece, a gripping force of 10 to 20 times the mass of the workpiece is generally required, depending on the friction coefficient between the surface of the workpiece and the contact surface of the hand with the workpiece. Naturally, the greater the required gripping force, the larger the driving means, such as a motor or an air cylinder, that generates the power to grip the workpiece. Therefore, if the workpiece is light, such as a 350 ml beverage can, there is no need to increase the size of the driving means and the increase in size of the hand can be avoided; however, if the workpiece is heavy, such as a 2 L PET bottle, the size of the driving means increases and the size of the hand increases. When the size of the hand increases, the weight of the hand inevitably increases, and in some cases, a robot with a larger load capacity needs to be used, which may lead to higher costs. In addition, when the size of the hand increases, it may be difficult to grasp a small workpiece, and as an example of means for solving this problem, Patent Literature 1 discloses a robot hand capable of grasping objects of various sizes.

### CITATION LIST

### Patent Literature

Patent Literature 1: Japanese Unexamined Patent Application Publication No. 2005-335025

### BRIEF DESCRIPTION OF THE DRAWINGS

FIG. 1 is a perspective view showing an example of a robot hand according to the present embodiment.

FIG. 2 is a plan view of the robot hand shown in FIG. 1.

FIG. 3 is a front view of the robot hand shown in FIG. 1.

FIG. 4 is a diagram showing an inner structure of a finger tip of the robot hand shown in FIG. 1.

FIG. 5 is a diagram for explaining a pick-up process of a workpiece with irregularities on the outer peripheral surface by the robot hand according to the present embodiment.

FIG. 6 is a diagram for explaining a pick-up process of a workpiece with no irregularities on the outer peripheral surface by the robot hand according to the present embodiment.

FIG. 7 is a diagram showing a jaw member of a robot hand according to a first modification of the present embodiment.

FIG. 8 is a plan view showing a state where a workpiece with irregularities on the outer peripheral surface is held by the robot hand according to the first modification of the present embodiment.

FIG. 9 is a plan view showing a state where a workpiece with no irregularities on the outer peripheral surface is held by the robot hand according to the first modification of the present embodiment.

FIG. 10 is a diagram showing a jaw member of a robot hand according to a second modification of the present embodiment.

FIG. 11 is a plan view showing a state where a workpiece with irregularities on the outer peripheral surface is held by the robot hand according to the second modification of the present embodiment.

FIG. 12 is a plan view showing a state where a workpiece with no irregularities on the outer peripheral surface is held by the robot hand according to the second modification of the present embodiment.

FIG. 13 is a diagram showing a jaw member of a robot hand according to a third modification of the present embodiment.

FIG. 14 is a plan view showing a state where a workpiece with irregularities on the outer peripheral surface is held by the robot hand according to the third modification of the present embodiment.

FIG. 15 is a plan view showing a state where a workpiece with no irregularities on the outer peripheral surface is held by the robot hand according to the third modification of the present embodiment.

### DETAILED DESCRIPTION

A robot hand according to one aspect of the present disclosure includes a pair of fingers provided so as to freely approach and separate from each other in order to hold a workpiece therebetween, and a pair of jaw members provided on the pair of fingers, respectively, in order to hook another workpiece. The jaw members are provided so as to be changeable between a state of protruding from contact surfaces of the fingers with the workpiece and a state of being pushed into the fingers.

Hereinafter, a robot hand according to an embodiment of the present invention will be described with reference to the drawings. In the following description, constituent elements having substantially the same function and configuration are denoted by the same reference numeral, and repetitive descriptions will be given only where necessary.

The robot hand according to the present embodiment can be used to pick two types of workpieces, i.e., a workpiece with irregularities on the outer peripheral surface such as a PET bottle and a workpiece with no irregularities on the outer peripheral surface such as a beverage can. In the present embodiment, a workpiece with irregularities on the outer peripheral surface is distinguished as a first workpiece, and a workpiece with no irregularities on the outer peripheral surface is distinguished as a second workpiece. The robot hand according to the present embodiment picks up the first workpiece by inserting a pair of jaw members into a recess and hooking the first workpiece. Therefore, the first workpiece includes a workpiece with a recess formed in the outer peripheral surface, a workpiece with a flange, and any other workpiece with a portion on which a jaw member is hooked. The robot hand according to the present embodiment picks up a second workpiece by holding the second workpiece between a pair of fingers. Therefore, the second workpiece may be a workpiece with irregularities on the outer peripheral surface as long as the workpiece can be held between the pair of fingers.

The robot hand according to the present embodiment is typically mounted on a robot arm mechanism so that the position and orientation of the robot hand can be changed. Of course, the mechanism equipped with the robot hand is not limited to the robot arm mechanism.

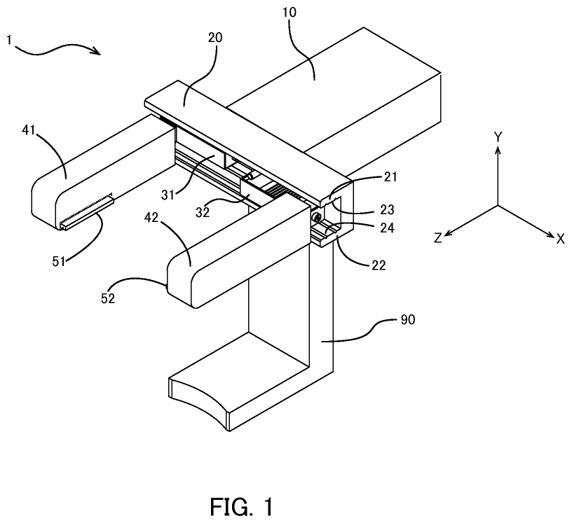

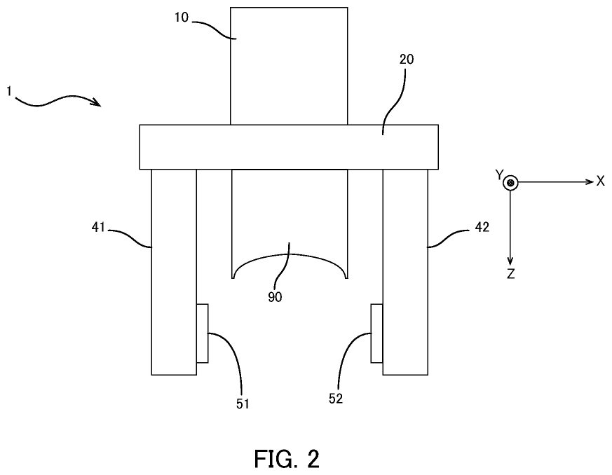

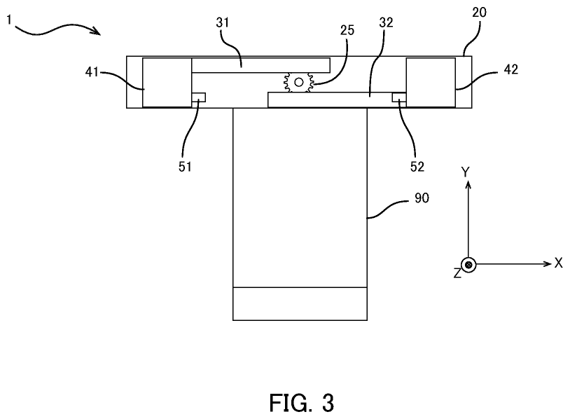

FIG. 1, FIG. 2, and FIG. 3 are a perspective view, a plan view, and a front view showing an example of a robot hand 1 according to the present embodiment, respectively. As shown in FIG. 1 to FIG. 3, the robot hand 1 includes a rectangular parallelepiped-shaped hand base 10. The hand base 10 is provided with an adapter (not shown) for connecting to a hand attachment portion of the robot arm mechanism. The hand base 10 is also provided with a support member 90 having a support surface for supporting the workpiece in order to suppress the sway of the workpiece picked up using at least one of the pair of fingers 41 and 42 and the pair of jaw members 51 and 52. The hand base 10 is connected to a rail base 20 which forms a groove frame body having a U-shaped transverse cross section and an open front side. A pair of linear rails 23 and 24 are laid along the width direction on the inner side surfaces of a pair of side walls 21 and 22 constituting the rail base 20. A pair of slider blocks 31 and 32 are movably fitted in the pair of rails 23 and 24. A pair of fingers 41 and 42 are fixed to the pair of slider blocks 31 and 32, respectively.

Hereinafter, the orthogonal three axes are defined as follows and used as appropriate. That is, an axis parallel to a direction (left-right direction) in which the pair of linear rails 23 and 24 provided on the pair of side walls of the rail base 20 are laid is defined as an X axis, a direction (up-down direction) in which the pair of side walls 21 and 22 face each other is defined as a Y axis, and an axis orthogonal to the X axis and the Y axis is defined as a Z axis.

The fingers 41 and 42 are configured as elongated straight columns having the same shape and dimensions. The fingers 41 and 42 are fixed at their ends to the slider blocks 31 and 32, respectively, so that the central axes of the fingers 41 and 42 are parallel to the Z axis. Typically, the inner side surfaces of the pair of fingers 41 and 42 are configured to be flat so that the pair of fingers 41 and 42 can easily hold the workpiece therebetween. The term “flat” here means parallel to the YZ plane. The inner side surfaces of the fingers 41 and 42 are contact surfaces which come into contact with the workpiece when the workpiece is held between the fingers 41 and 42.

The movement of the pair of fingers 41 and 42 is driven by a drive mechanism. The drive mechanism includes a motor unit (not shown). The motor unit is provided in the hand base 10. The motor unit includes a motor that generates power to move the pair of fingers 41 and 42 and, if necessary, a reduction gear that reduces the rotation of the motor. A drive gear 25 is connected to the drive shaft of the motor unit. As shown in FIG. 3, the drive gear 25 is disposed between the slider blocks 31 and 32 fitted in the pair of rails 23 and 24. A linear gear is formed on the lower surface of the upper slider block 31 and is meshed with the upper side of the drive gear 25. Similarly, a linear gear is formed on the upper surface of the lower slider block 32 and is meshed with the lower side of the drive gear 25. When the motor rotates in a forward direction, the pair of fingers 41 and 42 move together with the pair of slider blocks 31 and 32 in directions to approach each other. When the motor rotates in a reverse direction, the pair of fingers 41 and 42 move together with the pair of slider blocks 31 and 32 in directions to separate from each other. In this manner, by controlling the driving of the motor, the pair of fingers 41 and 42 can be opened and closed to pick up a workpiece or release the picked-up workpiece.

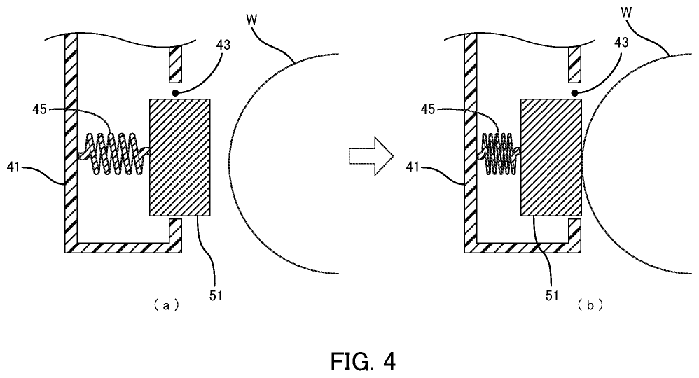

Hereinafter, the jaw member 51 will be described with reference to FIG. 4. Since the jaw member 52 has the same shape and dimensions as the jaw member 51, a detailed description thereof will be omitted. As shown in FIG. 4, the jaw member 51 is typically configured as a wide thin plate body having a rectangular shape in plan view. Here, the plan view is a view from the Y-axis direction. By increasing the width of the jaw member 51, it is possible to allow the misalignment of the first workpiece in the width direction when the jaw members 51 and 52 are aligned with the recess of the first workpiece, and to reduce the possibility that the held first workpiece falls off from the jaw members 51 and 52 due to sway or the like. On the inner side surface on the tip side of the finger 41, a linear slit 43, which is longer than the width of the jaw member 51, is formed in parallel with the Z axis. The jaw member 51 is inserted into the slit 43 on the inner side surface of the finger 41, and is supported at its base portion by a compression coil spring 45 fixed inside the finger 41.

As shown in FIG. 4(a), the jaw member 51 is urged toward the outside of the finger 41 by the compression coil spring 45, and protrudes from the inner side surface of the finger 41 in a steady state in which no load is applied. Further, by pushing the jaw member 51 in against the urging force of the compression coil spring 45, at least a part of the jaw member 51 can be housed inside the finger 41. In this manner, the jaw member 51 is provided changeably between a state of protruding from the inner side surface of the finger 41 and a state of being housed inside the finger 41. Typically, as shown in FIG. 4(b), the dimensions and the like of the finger 41, the jaw member 51, and the compression coil spring 45 are designed so that the jaw member 51 can be completely housed inside the finger 41 when the jaw member 51 is pressed by the workpiece W. Further, in order to prevent the jaw member 51 from scratching the workpiece W when the jaw member 51 is pushed by the workpiece W, it is preferable to use a compression coil spring 45 having a small spring constant which contracts even with a small force. A guide mechanism may be provided to guide the linear movement of the jaw member 51 when the jaw member 51 is pushed toward the inside of the finger 41 or when the jaw member 51 pushed into the finger 41 returns to its original state.

The robot hand 1 according to the present embodiment can pick up the first workpiece with irregularities on the outer peripheral surface, as follows: Here, descriptions will be provided assuming that the first workpiece is a PET bottle 100. The PET bottle 100 has a cylindrical body portion 100a having a bottom, a neck portion 100b formed so as to be narrowed toward a mouth portion, a cap 100c for covering the opening of the mouth portion, and an annular neck ring 100d provided between the neck portion and the mouth portion and protruding outward. A recess is formed below the neck ring 100d.

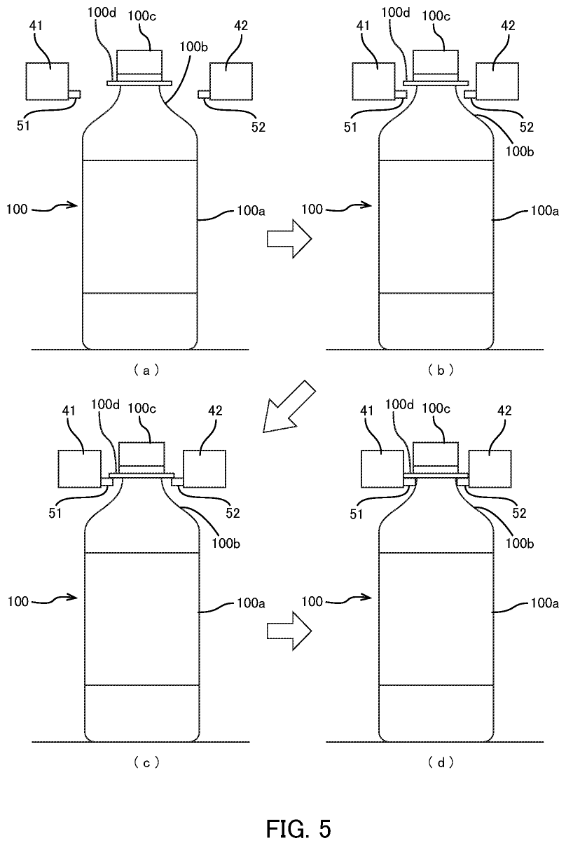

As shown in FIG. 5(a), the robot hand 1 is moved by the robot arm mechanism to a position where the jaw members 51 and 52 are inserted into the recess below the neck ring 100d of the PET bottle 100. Next, the pair of fingers 41 and 42 are moved in the directions in which they approach each other to such an extent that the inner side surfaces of the fingers 41 and 42 do not contact the outer peripheral surface of the neck ring 100d. As a result, as shown in FIG. 5(b), the jaw members 51 and 52 are inserted into the recess below the neck ring 100d of the PET bottle 100. In this state, the robot hand 1 is moved upward by the robot arm mechanism, whereby, as shown in FIG. 5(c), the upper surfaces of the jaw members 51 and 52 come into contact with the lower end surface of the neck ring 100d of the PET bottle 100, and the PET bottle 100 can be lifted with the neck ring 100d of the PET bottle 100 hooked by the jaw members 51 and 52.

As shown in FIG. 5(d), the pair of fingers 41 and 42 are further moved in the directions in which they approach each other until the inner side surfaces of the fingers 41 and 42 come into contact with the outer peripheral surface of the neck ring 100d and the outer peripheral surface of the neck ring 100d is pressed from both sides by the fingers 41 and 42. Since the outer peripheral surface of the neck ring 100d is pressed by the fingers 41 and 42 from both sides, when the PET bottle 100 is hooked and lifted or moved in the horizontal direction by the jaw members 51 and 52, the sway of the PET bottle 100 can be suppressed and the posture thereof can be stabilized. By stabilizing the posture of the PET bottle 100, it is possible to reduce the possibility that the PET bottle 100 falls off from the robot hand 1 and to release the PET bottle 100 in a correct posture.

The robot hand 1 according to the present embodiment adopts a method of inserting the jaw members 51 and 52 into a recess of the first workpiece and hooking the first workpiece as a method for lifting the first workpiece with irregularities on the outer peripheral surface. Since the pair of fingers 41 and 42 only press the outer peripheral surface of the first workpiece from both sides in order to stabilize the posture of the first workpiece, it is not necessary to increase the gripping force of the pair of fingers 41 and 42 depending on the weight of the first workpiece, and only the strength of the component itself or the connection strength of the component needs to be improved. Therefore, since there is no need to use a large motor to increase the gripping force of the pair of fingers 41 and 42, it is possible to prevent the size of the robot hand 1 from increasing.

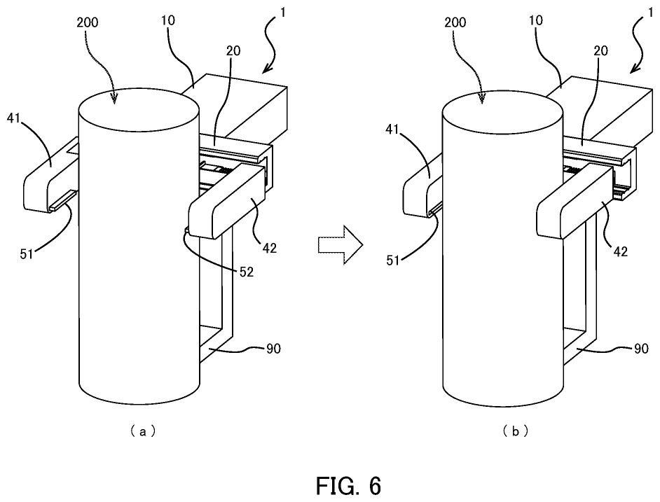

The robot hand 1 according to the present embodiment can pick up the second workpiece while holding the flat outer peripheral surface of the second workpiece. As the second workpiece, typically, a cylindrical beverage can 200 without no irregularities on the outer peripheral surface is assumed. As shown in FIG. 6(a), the robot hand 1 is positioned by the robot arm mechanism so that the pair of fingers 41 and 42 are disposed on both sides of the beverage can 200. The pair of fingers 41 and 42 are then moved in the directions in which they approach each other until the inner side surfaces of the fingers 41 and 42 come into contact with the outer peripheral surface of the beverage can 200. As they move, as shown in FIG. 6(b), the jaw members 51 and 52 are pushed into the fingers 41 and 42 by the beverage can 200, and the inner side surfaces (contact surfaces) of the pair of fingers 41 and 42 come into surface contact with the outer peripheral surface of the beverage can 200. Further, the pair of fingers 41 and 42 are moved in the directions in which they approach each other, whereby the outer peripheral surface of the beverage can 200 is strongly pressed by the contact surfaces of the pair of fingers 41 and 42, and the beverage can 200 is held between the pair of fingers 41 and 42. In this manner, the robot hand 1 can pick up the beverage can 200 by utilizing the frictional force generated between the inner side surfaces of the pair of fingers 41 and 42 and the outer peripheral surface of the beverage can 200.

According to the robot hand 1 of the present embodiment, since the jaw members 51 and 52 can be completely housed inside the fingers 41 and 42, when the beverage can 200 is held between the pair of fingers 41 and 42, the contact surfaces of the fingers 41 and 42 which come into contact with the beverage can 200 can be secured to the same extent as when the fingers 41 and 42 are not provided with the jaw members 51 and 52. Further, since the beverage can 200 can be held between the wide contact surfaces of the fingers 41 and 42 rather than the narrow contact surfaces of the jaw members 51 and 52, the beverage can 200 can be stably held, and the surface pressure acting on the beverage can 200 can be reduced. Since the surface pressure acting on the beverage can 200 can be reduced, the outer peripheral surface of the beverage can 200 is less likely to be scratched by the gripping.

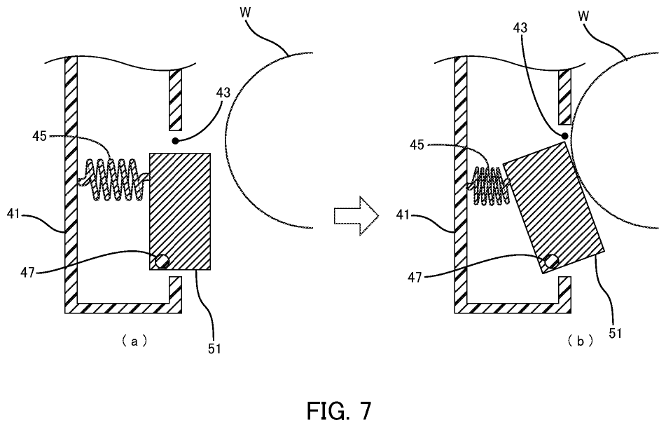

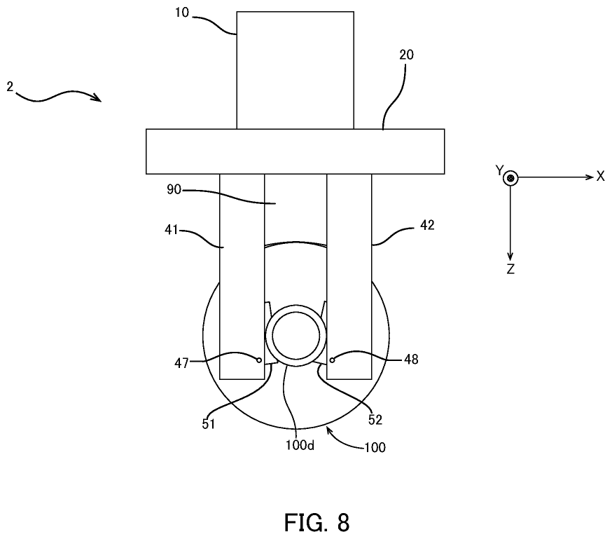

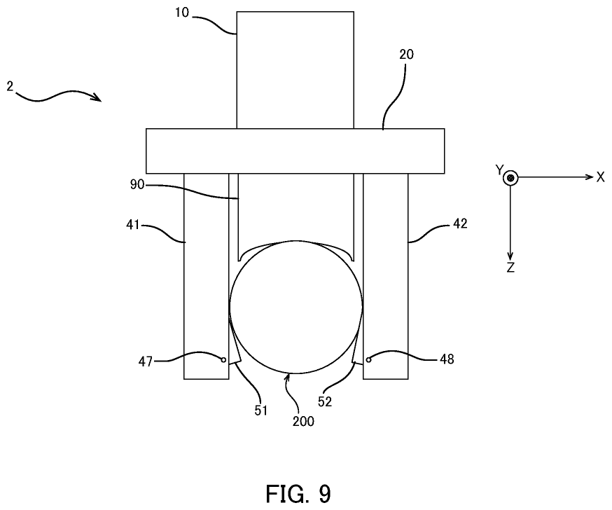

A robot hand 2 according to a first modification of the present embodiment will be described below with reference to FIG. 7, FIG. 8, and FIG. 9. The structural difference between the robot hand 1 according to the present embodiment and the robot hand 2 according to the first modification is that, in the robot hand 2 according to the first modification, the jaw members 51 and 52 are supported rotatably with respect to the fingers 41 and 42.

FIG. 7 shows a support structure of the jaw member 51 inside the finger 41. Since the jaw member 52 is supported by the finger 42 with the same support structure as the jaw member 51, a detailed description thereof will be omitted. As shown in FIG. 7, the jaw member 51 is rotatably supported by a shaft 47 provided inside a tip side part of the finger 41 so that the central axis thereof is parallel to the Y axis. As shown in FIG. 7(a), in the steady state in which no load is applied to the jaw member 51, the jaw member 51 protrudes from the inner side surface of the finger 41. This is the same as in the present embodiment. On the other hand, when the jaw member 51 is pushed in by the workpiece W against the urging force of the compression coil spring 45, as shown in FIG. 7(b), the end portion of the jaw member 51 located on the root side of the finger 41 pivots toward the finger 41.

As shown in FIG. 8, according to the robot hand 2 of the first modification of the present embodiment, in a state in which the neck ring 100d of the PET bottle 100 are hooked by the jaw members 51 and 52 and the neck ring 100d of the PET bottle 100 is pressed from both sides by the fingers 41 and 42, the end portions of the jaw members 51 and 52 located on the tip sides of the fingers 41 and 42 can protrude from the inner side surfaces of the fingers 41 and 42 more than the end portions of the jaw members 51 and 52 located on the root sides of the fingers 41 and 42. In other words, the distance between the pair of jaw members 51 and 52 can be gradually narrowed from the root sides to the tip sides of the fingers 41 and 42. As a result, the jaw members 51 and 52 can also function as a stopper that prevents the PET bottle 100 held by the robot hand 2 from slipping between the jaw members 51 and 52 and falling off to the tip sides of the fingers 41 and 42. The movement of the PET bottle 100 held by the robot hand 2 to the left and right sides is stopped by the pair of fingers 41 and 42, the downward fall of the PET bottle 100, and the forward movement of the PET bottle 100 are stopped by the jaw members 51 and 52, and the backward movement of the PET bottle 100 is stopped by the support member 90. In this manner, the PET bottle 100 can be supported from the front, back, left, right, and below, reducing the possibility of the PET bottle 100 falling off from the robot hand 2.

As shown in FIG. 9, according to the robot hand 2 of the first modification of the present embodiment, even when the beverage can 200 is disposed at a position where the beverage can 200 interferes with the pair of jaw members 51 and 52, the pair of jaw members 51 and 52 are pushed into the beverage can 200 to pivot. Therefore, the beverage can 200 can be held not between the narrow tip surfaces of the pair of jaw members 51 and 52 but between the wide inner side surfaces of the pair of fingers 41 and 42. Further, similarly to the robot hand 1 according to the present embodiment, in a state in which the beverage can 200 is held between the pair of fingers 41 and 42, the jaw members 51 and 52 can also function as a stopper that prevents the beverage can 200 held between the pair of fingers 41 and 42 from slipping between the jaw members 51 and 52 and falling off to the tip sides of the fingers 41 and 42.

In the first modification, the jaw members 51 and 52 are rotatably supported on the shaft 47 provided near the tips of the fingers 41 and 42 so as to function as a stopper that prevents the workpiece from falling off from the tip sides of the fingers 41 and 42. This function can also be realized by modifying the shapes of the jaw members 51 and 52. Hereinafter, in second and third modifications, modifications of the jaw members 51 and 52 will be described.

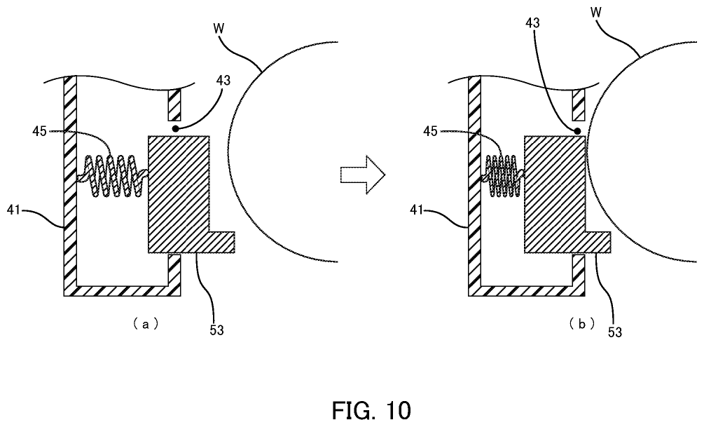

As shown in FIG. 10, in a robot hand 3 according to the second modification of the present embodiment, a jaw member 53 is formed in a thin plate-shaped body having an L-shape in plan view, and is disposed so that a portion located on the tip side of the finger 41 protrudes outward from the inner side surface of the finger 41 as compared with the other portions. As shown in FIG. 10(a), in the steady state in which no load is applied to the jaw member 53, the jaw member 53 protrudes from the inner side surface of the finger 41. When the jaw member 53 is pushed in by the workpiece W against the urging force of the compression coil spring 45, as shown in FIG. 10(b), an end portion of the jaw member 53 located on the tip side of the finger 41 remains protruding from the inner side surface of the finger 41.

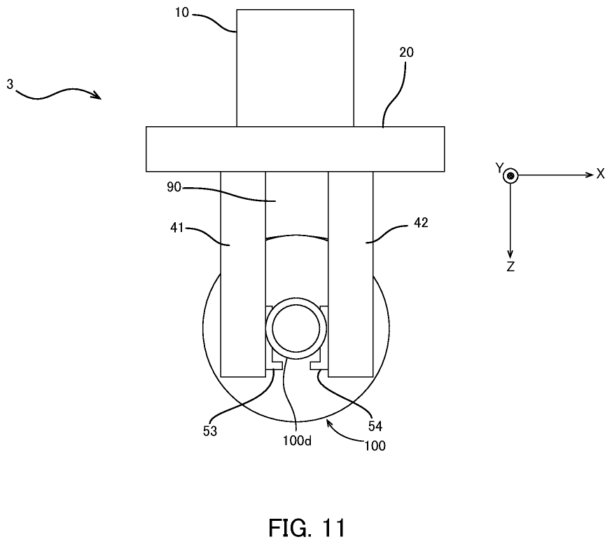

As shown in FIG. 11, according to the robot hand 3 of the second modification of the present embodiment, in a state in which the neck ring 100d of the PET bottle 100 is hooked by the jaw members 53 and 54 and the neck ring 100d of the PET bottle 100 is pressed from both sides by the fingers 41 and 42, only the end portions of the jaw members 53 and 54 located on the tip sides of the fingers 41 and 42 can protrude from the inner side surfaces of the fingers 41 and 42. Accordingly, the jaw members 53 and 54 can also function as a stopper that prevents the PET bottle 100 held by the robot hand 3 from slipping between the jaw members 53 and 54 and falling off to the tip sides of the fingers 41 and 42.

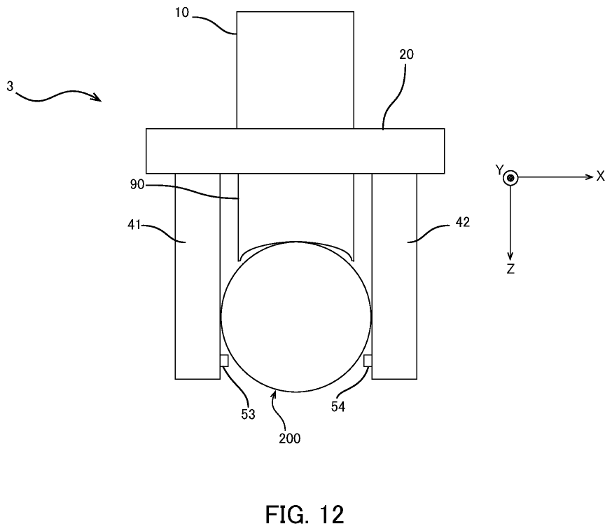

Similarly, as shown in FIG. 12, according to the robot hand 3 of the second modification of the present embodiment, similarly to the robot hand 1 according to the present embodiment, the beverage can 200 can be held between the pair of fingers 41 and 42, and the jaw member 53 and 54 can also function as a stopper that prevents the beverage can 200 held between the pair of fingers 41 and 42 from slipping between the jaw members 53 and 54 and falling off to the tip sides of the fingers 41 and 42.

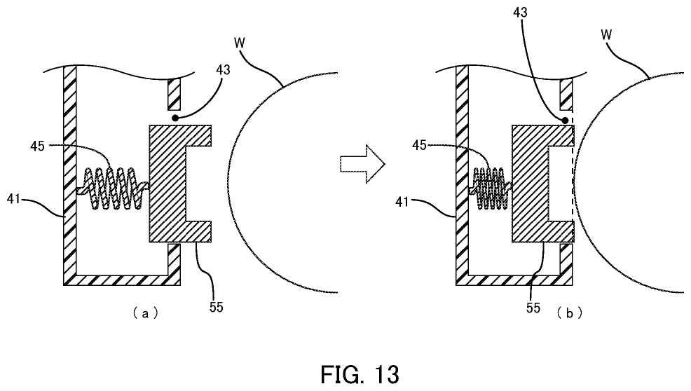

As shown in FIG. 13, in the robot hand 4 according to the third modification of the present embodiment, the jaw member 55 is formed in a thin plate-shaped body having a U-shape in plan view, and is disposed so that portions located on the tip side and the root side of the finger 41 protrude outward from the inner side surface of the finger 41 as compared with the other portions. As shown in FIG. 13(a), in the steady state in which no load is applied to the jaw member 53, the jaw member 55 protrudes from the inner side surface of the finger 41. When the jaw member 55 is pushed in by the workpiece W against the urging force of the compression coil spring 45, as shown in FIG. 13(b), the jaw member 55 is completely housed inside the finger 41.

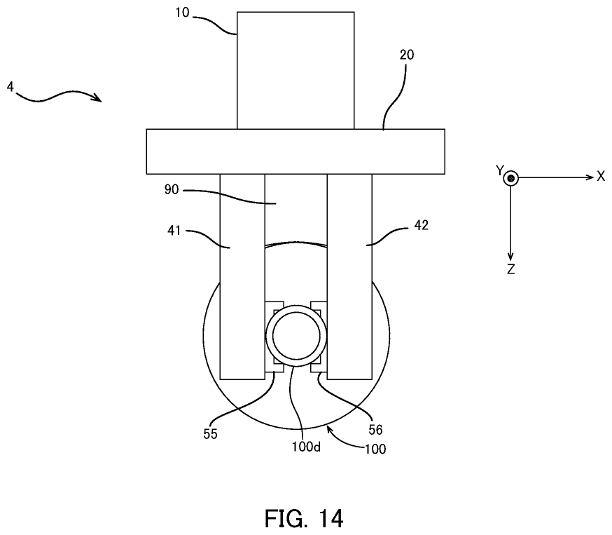

As shown in FIG. 14, according to the robot hand 4 of the third modification of the present embodiment, in a state in which the neck ring 100d of the PET bottle 100 is hooked by the jaw members 55 and 56 and the neck ring 100d of the PET bottle 100 is pressed from both sides by the fingers 41 and 42, the neck ring 100d can be surrounded by the jaw members 55 and 56 on the four sides (front, back, left, and right). Accordingly, the jaw members 55 and 56 can also function as a stopper that prevents the PET bottle 100 held by the robot hand 4 from slipping between the jaw members 55 and 56 and falling off to the tip sides and the root sides of the fingers 41 and 42.

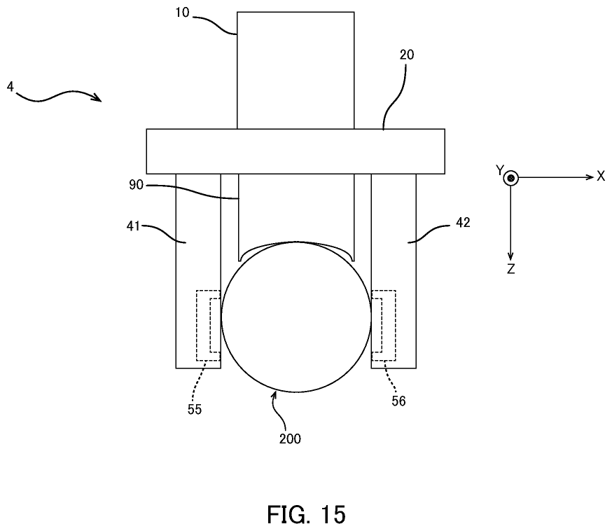

Similarly, as shown in FIG. 15, according to a robot hand 4 of the third modification of the present embodiment, the beverage can 200 can be held between the pair of fingers 41 and 42 in the same manner as in the robot hand 1 according to the present embodiment.

In the robot hand according to the present embodiment, the shape and dimensions of the fingers, the shape and dimensions of the jaw members, and the positions of the jaw members on the fingers can be changed as appropriate in accordance with the type and size of the workpiece to be picked up. In the present embodiment, since the lower end surface of the neck ring 100d of the PET bottle 100 with which the jaw members 51 and 52 come into contact is flat, the upper surfaces of the jaw members 51 and 52 are configured to be flat, but it is not essential that the upper surfaces of the jaw members 51 and 52 be flat. For example, if the surface of the workpiece with which the upper surfaces of the jaw members 51 and 52 come into contact have irregularities, the upper surfaces of the jaw members 51 and 52 can be formed in a shape that matches the surface of the workpiece. In addition, the upper surfaces of the jaw members 51 and 52 may be provided with an anti-slip pad or an anti-slip embossing.

In the present embodiment, the fingers, the jaw members, and the compression coil spring are configured such that the jaw members can be completely housed inside the fingers in a state of being pushed in by the workpiece. However, as in the robot hand 3 according to the second modification of the present embodiment, in a case where parts of the jaw member 53 and 54 protrude from the inner side surfaces of the fingers 41 and 42 when the jaw members 53 and 54 are pushed in by the workpiece so that the jaw members 53 and 54 also function as a member that prevents the workpiece from falling off, the fingers 41 and 42, the jaw members 53 and 54, and the compression coil spring 45 may be configured such that the jaw members 53 and 54 cannot be completely housed inside the fingers 41 and 42 in the state of being pushed in by the workpiece.

Although the robot hand 1 according to the present embodiment is provided with the support member 90 for suppressing the sway of the workpiece, the support member 90 is not essential and may be omitted depending on the type, size, and the like of the workpiece to be handled.

Pads may be attached to the inner side surfaces of the fingers 41 and 42, respectively, in order to increase the frictional force between the fingers 41 and 42 and the workpiece. The pads are attached to the inner side surfaces of the fingers 41 and 42 except for the slits 43 and 44. The pad is an elastic body, more specifically, a rubber or synthetic resin plate-shaped body with spongy air bubbles. The pad may be an inflatable bag.

Although the pair of fingers 41 and 42 are of a parallel opening/closing type, which opens and closes by moving parallel to each other, the opening/closing method is not limited thereto as long as the inner side surfaces of the fingers 41 and 42, which are the contact surfaces that contact the beverage can 200, can freely approach and separate from each other. For example, of the pair of fingers 41 and 42, one finger 41 may be fixed and only the other finger 42 may be moved. It is also possible to adopt a rotary opening/closing type in which the pair of fingers 41 and 42 are provided rotatably at their root side ends and open and close by rotating so as to approach and separate from each other.

The urging member is not limited to the compression coil spring 45 as long as it can urge the jaw members 51 and 52 toward the outside of the fingers 41 and 42. For example, the urging member may be other springs such as plate springs, or other types of urging members such as rubber. Further, a driving mechanism that drives the movement of the jaw members 51 and 52 may be provided so that the movement of the jaw members 51 and 52 can be controlled. From the viewpoint of enabling the jaw members 51 and 52 to be housed in the fingers 41 and 42, the urging member is not necessarily required. For example, instead of making the jaw members 51 and 52 retractable along the horizontal direction (X direction (see FIG. 3)), they may be configured to be retractable along a direction slightly tilted downward from the horizontal direction. As a result, the jaw members 51 and 52 pressed by the workpiece and housed in the fingers 41 and 42 can be changed into a state of protruding from the inner side surfaces of the fingers 41 and 42 by their own weight when released from the pressing by the workpiece.

In the present embodiment, a motor is employed as a drive source for driving the pair of fingers 41 and 42, but the drive source is not limited thereto. For example, another mechanism such as an air cylinder or a hydraulic cylinder can be employed as the drive source of the pair of fingers 41 and 42.

While some embodiments of the present invention have been described, these embodiments have been presented as examples, and are not intended to limit the scope of the invention. These embodiments can be implemented in various other forms, and various omissions, replacements, and changes can be made without departing from the spirit of the invention. These embodiments and their modifications are included in the scope and spirit of the invention and are included in the scope of the claimed inventions and their equivalents.

1. A robot hand comprising:
a pair of fingers provided so as to freely approach and separate from each other in order to hold a workpiece therebetween; and
a pair of jaw members provided on the pair of fingers, respectively, in order to hook another workpiece, wherein
the jaw members are provided so as to be changeable between a state of protruding from contact surfaces of the fingers with the workpiece and a state of being pushed into the fingers.

2. The robot hand according to claim 1, wherein the fingers are formed as straight columns with flat contact surfaces.

3. The robot hand according to claim 1, further comprising an urging member configured to urge the jaw members in a direction to protrude from the contact surfaces.

4. The robot hand according to claim 1, wherein the jaw members are provided on tip sides of the fingers.

5. The robot hand according to claim 1, wherein the jaw members are configured in a wide thin plate shape.

6. The robot hand according to claim 5, wherein the jaw members are formed in an L-shape in plan view.

7. The robot hand according to claim 5, wherein the jaw members are formed in a U-shape in plan view.

8. The robot hand according to claim 1, wherein the jaw members can be completely housed inside the fingers.

9. The robot hand according to claim 1, wherein the jaw members are rotatably supported by the fingers at tip sides of the fingers.

10. The robot hand according to claim 1, wherein the robot hand includes a support member for suppressing sway of the workpiece held between the pair of fingers or the another workpiece hooked by the pair of jaw members.
